(19) United States
(12) Patent Application Publication
(10) Pub. No.: US 2003/0185511 A1
(43) Pub. Date: Oct. 2, 2003

(54) Optical grating device

(76) Inventors: Paul A. Kirkby, Essex (GB); James E. Whiteaway, Hertfordshire (GB)

Correspondence Address: Lee, Mann, Smith, McWilliams, Sweeney & Ohlson, P.O. Box 2786, Chicago, IL, 60690-2786, US

(21) Appl. No.: 10/109,916

(22) Filed: Mar. 29, 2002

(51) Int. Cl. G02B 6/34; G02B 6/293

(52) U.S. Cl. 385/37; 385/24

(57) ABSTRACT

The invention is directed to an optical grating device which is capable of processing at least two optical signals concurrently, comprising a plurality of input waveguides, a plurality of output waveguides, a first free propagating region and a second free propagating region, and a composite light pathway. These are arranged such that a first input waveguide and a first output waveguide are connected to said first region; a second input waveguide and a second output waveguide are connected to said second region; and said first region and said second region are connected by the composite light pathway. Light input along the first input waveguide is able to pass through the composite light pathway to be output through the second output waveguide and light input along the second input waveguide is able to pass through the composite light pathway to be output through the first output waveguide.

An advantage of such an optical grating device is that it combines the function of two optical grating devices into a single device, this leads to many advantages including reducing size, cost and power consumption.

### FIELD OF THE INVENTION

The present invention relates to an optical grating device.

### BACKGROUND TO THE INVENTION

An optical communications system comprises a light source, such as a laser, a medium through which the light is transmitted, such as an optical fibre and a means of detecting the light, such as a photodetector. The component containing the light source is known as the transmitter and the component containing the detecting means is known as the receiver. The purpose of a communications system is to transfer information from one location to another. The output from the light source is modulated to encode this information and the modulation is detected by the receiver such that data is transmitted through the system.

The term “light” with reference to an optical communications system is used herein to refer to electromagnetic radiation from any part of the electromagnetic spectrum.

As the requirement to transfer data across an optical communication system increases, there are two techniques which are commonly used to increase the system capacity. The first technique involves increasing the rate at which the light is modulated which permits more data to be transmitted in a given time. The second technique involves using more than one wavelength of light to transmit more than one stream or channel of data concurrently. This second technique is known as wavelength division multiplexing and an optical communications system which uses this technique is called a wavelength division multiplexed system, or WDM system. The first and second techniques are often used in combination by both increasing the modulation rate and using more than one wavelength of light. In reality a stream of data is not transmitted on a single wavelength, but on a small range of wavelengths. The size of the wavelength range is dependent on the exact system implementation, but is typically 0.3 nm for a 10 Gbit/s system. Hereafter the term “wavelength” with reference to a channel of data is taken to mean the centre wavelength of the transmitted light, accepting that there will be a small spread of wavelengths around this value.

A schematic diagram of a simple WDM system is shown in FIG. 1. The system comprises a plurality of transmitters 102 and the output light from each transmitter is of a different wavelength. The output light from each transmitter is combined on to a single transmitting medium 104, such as an optical fibre, by means of an optical multiplexor 106. At the other end of the system, the individual wavelengths are separated by means of an optical demultiplexor 108 and detected by different detectors 110. The optical multiplexors and demultiplexors 106, 108 are examples of optical filters.

The system shown in FIG. 1 transmits four channels of light each on a different wavelength. In real systems, there may be many more than four channels, and the system may not be a point to point link with all four channels going from one location to a second location.

A schematic diagram of a simple communications network is shown in FIG. 2. Information is sent from location A 202 to location B 204 and to location C 206 along optical links 208, 210. In the past, all the information sent along the optical link from A to B 208 would have been received at point B, where the final destination of the information was determined and any information which was intended for location C was then retransmitted along the optical link from B to C 210. This is not the most efficient use of transmitting and receiving equipment as transmitters and receivers are required at location B to deal with information which is travelling from A to C.

A schematic diagram of a more efficient network is shown in FIG. 3. An extra network element 302 has been added which is called an Optical Add Drop Multiplexor (OADM). The OADM splits off the information which is travelling from A to B but allows any information which needs to go from A to C to pass straight through. The OADM can also be used to add information which needs to be transmitted from B to C.

A schematic diagram of an OADM is shown in FIG. 4. The optical signal enters the OADM 302 along the optical input path 404. A demultiplexor 406 splits the optical signal into two groups of wavelengths (or channels). The first group of wavelengths is then input to a second demultiplexor 408, which is also called a band drop filter. The band drop filter 408 splits the group of wavelengths into 4 bands of wavelengths. The first of these bands is then input to a third demultiplexor 410 also called a channel drop filter. The channel drop filter splits the band into the separate wavelengths (or channels) and outputs each down a separate output 411, 412, 413, 414. These four outputs carry the information which is being dropped at this OADM 302. Referring back to FIG. 3, this is the information which is being sent from location A to location B.

Information which needs to be sent from location B to location C can also be added via the OADM 302. Wavelengths which have carried information from A to B can be reused to carry this information, and the information is input on four channels through four inputs 416, 417, 418, 419 with a single channel on each input. These four wavelengths are combined by a multiplexor 420 also called a channel add filter. This multiplexed signal carrying a band of wavelengths is then multiplexed with the three other wavelength bands by another multiplexor 422. The output of this multiplexor is multiplexed with the other group of wavelengths by a further multiplexor 424 and the combined signal is output from the OADM 302 along the optical output path 426.

The demultiplexors 406, 408, 410 and the multiplexors 420, 422, 424 can be made from a number of different technologies including, but not limited to, dielectric filter devices, fibre grating devices, diffraction grating devices and arrayed waveguide grating devices.

An arrayed waveguide grating (AWG) is also known as a PHASAR based device, and is hereafter referred to as an AWG. Such devices are discussed in detail in ‘PHASAR-Based WDM-Devices: Principles, Design and Applications’ by M. K. Smit and Cor van Dam, published in the IEEE Journal of Selected Topics in Quantum Electronics, Vol. 2, No. 2, June 1996, and a basic description is included here.

A schematic layout of a simple 1×4 AWG is shown in FIG. 5. Such a device could be used for either the channel drop filter 410 or the channel add filter 420 as shown in FIG. 4. The device shown in FIG. 5 has 1 input port 502 and 4 output ports 504. The AWG additionally comprises 2 free propagating regions 506, 508, also known as star couplers, which are connected by a plurality of optical waveguides 510, each of which has a different optical path length. These waveguides 510 are hereafter referred to as the array of waveguides.

The operation of the AWG shown in FIG. 5 when used as a demultiplexor is as follows. A beam of light propagates down the input port 502 and when the beam of light enters the star coupler 506 it is no longer laterally confined and the beam diverges. At the other end of the star coupler 506, the beam is coupled into the array of waveguides 510, and is propagated along these waveguides to the second star coupler 508. The array of waveguides 510, therefore define a composite light pathway between the first star coupler 506 and the second star coupler 508. The length of the waveguides within the array increases linearly across the array. This results in the focal point moving along the output plane of the second star coupler 512 as the wavelength changes. By placing the output guides 504 at the appropriate positions along this plane 512, a different wavelength or range of wavelengths is coupled to each output port.

The operation of such an AWG is reciprocal, such that the device shown in FIG. 5 could also be used as a multiplexor with guides 504 operating as 4 input ports and guide 502 operating as a single output port. The AWG operated in this manner would combine the 4 different wavelengths input one on each of the ports 504 onto the output port 502.

The term “reciprocal” with reference to the operation of an AWG is used herein to mean that the operation of an AWG is substantially reversible. This can be described with reference to FIG. 5, such that if the AWG was used as a demultiplexor and an input signal on port 502 contained 4 wavelengths, λ₁, λ₂, λ₃, λ₄, wavelength λ₁ would be output by the first of the output ports 504, wavelength λ₂ by the second etc. However, if the same AWG was used as a multiplexor, waveguides 504 become the input ports and waveguide 502 the output port, and if an input signal of wavelength λ₁ was input on the first input port 504, λ₂ on the second, λ₃ on the third and λ₄ on the fourth, all 4 wavelengths would be combined and output via the output port 502.

An AWG is a periodic device and the free spectral range (FSR) of an AWG device describes this periodicity, whereby if any pair of input and output port are chosen, and the input signal is scanned in frequency, a periodic response is received at the output port such that the spacing of the transmission peaks is defined as the FSR, as shown in FIG. 6. The trace 602 in FIG. 6 shows the transmission characteristic of a single output 504 of an AWG, as shown in FIG. 5, and the spacing of the transmission peaks Af is defined as the FSR of the device.

There are many problems with current network elements such as OADMs, as shown in FIG. 4, including size, cost and power consumption. These are three critical parameters for current network design, particularly when designing networks for metropolitan applications.

In the OADM 302 as shown in FIG. 4 there are 6 multiplexor/demultiplexor components and in reality an OADM may contain many more multiplexor/demultiplexor components. Each multiplexor/demultiplexor component is expensive and may require active temperature control to ensure that it operates at wavelengths which match those in the incoming signal. Active temperature control usually involves using a thermoelectric cooler or heater and a temperature sensing device. Thermoelectric coolers and heaters consume a lot of electrical power. This means that the size, cost and power consumption of a network element, such as an OADM increases as the number of multiplexor/demultiplexor components it contains increases.

It would therefore be beneficial if the number of multiplexor/demultiplexor components within a network element such as an OADM could be reduced without compromising the performance of the network element.

Of the components shown within the OADM 302 in FIG. 4, the same AWG device, as shown in FIG. 5, could be used for either the channel drop filter 410 or the channel add filter 420. A simple way to reduce the number of multiplexor/demultiplexor components within the OADM would therefore be to use the same device for both the channel drop filter and the channel add filter with light travelling in opposite directions through the device. However there are many problems associated with this, including the fact that back scattered light from interfaces and defects in the input and output waveguides is likely to cause unacceptably high crosstalk resulting in the device performance being so poor that it cannot be used.

Another problem with using the same AWG device as shown in FIG. 5 for both the channel drop filter and the channel add filter concurrently is that a component, such as a circulator, would be required on every input and output to merge and separate the signals travelling in opposite directions. Such components would introduce unacceptably high optical losses and are very expensive.

### OBJECT TO THE INVENTION

The invention seeks to provide an optical grating device which mitigates at least one of the problems described above.

Further benefits and advantages of the invention will become apparent from a consideration of the following detailed description given with reference to the accompanying drawings, which specify and show preferred embodiments of the invention.

### SUMMARY OF THE INVENTION

The invention is directed to an optical grating device which is capable of processing at least two optical signals concurrently, comprising a plurality of input waveguides, a plurality of output waveguides, a first free propagating region and a second free propagating region, and a composite light pathway. These are arranged such that a first input waveguide and a first output waveguide are connected to said first region; a second input waveguide and a second output waveguide are connected to said second region; and said first region and said second region are connected by the composite light pathway. Light input along the first input waveguide is able to pass through the composite light pathway to be output through the second output waveguide and light input along the second input waveguide is able to pass through the composite light pathway to be output through the first output waveguide.

The composite light pathway can be an array of waveguides. The composite light pathway can include a diffraction grating element.

Additionally, according to this invention, light input along a plurality of input waveguides is able to pass through the composite light pathway to be output through at least one output waveguide. Correspondinly, light input along at least one input waveguide is able to pass through the composite light pathway to be output through a plurality of output waveguides.

The optical grating device according to this invention subjects light travelling in a direction from the first free propagating region to the second free propagating region to a first optical processing function and also the optical grating device subjects light travelling in a direction from the second free propagating region to the first free propagating region to a second optical processing function.

An advantage of such an optical grating device is that it combines the function of two optical grating devices into a single device, this leads to many advantages including, but not limited to saving space (such an optical grating device is smaller than two conventional devices), reducing costs (such an optical grating device costs less to manufacture than two conventional devices) and reducing power consumption (there is only one optical grating device requiring active temperature control compared to two conventional devices).

A further advantage of such an optical grating device is that because separate waveguides are used for the input and output waveguides, no separate components are required to separate out the light travelling in opposite directions. This results in much lower optical loss and a lower cost component.

The first optical processing function and the second optical processing functions may be substantially the same and an example is that the first and second optical processing functions are both multiplexing or both demultiplexing functions.

The first optical processing function and the second optical processing functions may be different, and an example is that the first optical processing function is a multiplexing function and the second optical processing function is a demultiplexing function.

An optical grating device according to this invention may be fabricated in many materials including, but not limited to silica on silicon technology and silicon on silica technology.

An optical grating device according to this invention can be used as an integrated add-drop channel filter.

The invention is also directed to an optical network element containing an optical grating device as described herein. An example of such an optical network element is one for use as an optical add-drop multiplexor.

An advantage of this is that it reduces the size, cost and power consumption of the network element.

A further advantage of this invention is that it reduces the inventory of spares required.

The invention is further directed to an optical system containing an optical grating device which is capable of processing at least two optical signals concurrently, comprising a plurality of input waveguides, a plurality of output waveguides, a first free propagating region and a second free propagating region, and a composite light pathway. These are arranged such that a first input waveguide and a first output waveguide are connected to said first region; a second input waveguide and a second output waveguide are connected to said second region; and said first region and said second region are connected by the composite light pathway. Light input along the first input waveguide is able to pass through the composite light pathway to be output through the second output waveguide and light input along the second input waveguide is able to pass through the composite light pathway to be output through the first output waveguide.

An advantage of this is that it reduces the cost and power consumption of the optical system.

The invention is further directed to an optical grating device which is capable of processing at least two optical signals concurrently, comprising a plurality of input waveguides, a plurality of output waveguides, a first free propagating region and a second free propagating region, and a composite light pathway. These are arranged such that a first input waveguide and a first output waveguide are connected to said first region; a second input waveguide and a second output waveguide are connected to said second region; and said first region and said second region are connected by the composite light pathway, and wherein light travels in two directions through the array of waveguides and in predominantly one direction through any input or output waveguide.

The invention is further directed to an optical system containing an optical grating device which is capable of processing at least two optical signals concurrently, comprising a plurality of input waveguides, a plurality of output waveguides, a first free propagating region and a second free propagating region, and a composite light pathway. These are arranged such that a first input waveguide and a first output waveguide are connected to said first region; a second input waveguide and a second output waveguide are connected to said second region; and said first region and said second region are connected by the composite light pathway, and wherein light travels in two directions through the array of waveguides and in predominantly one direction through any input or output waveguide.

The preferred features may be combined as appropriate, as would be apparent to a skilled person, and may be combined with any of the aspects of the invention.

### BRIEF DESCRIPTION OF THE DRAWINGS

Reference will now be made, by way of example, to the accompanying drawings, in which:

FIG. 1 shows a schematic diagram of a Prior Art WDM optical communications system;

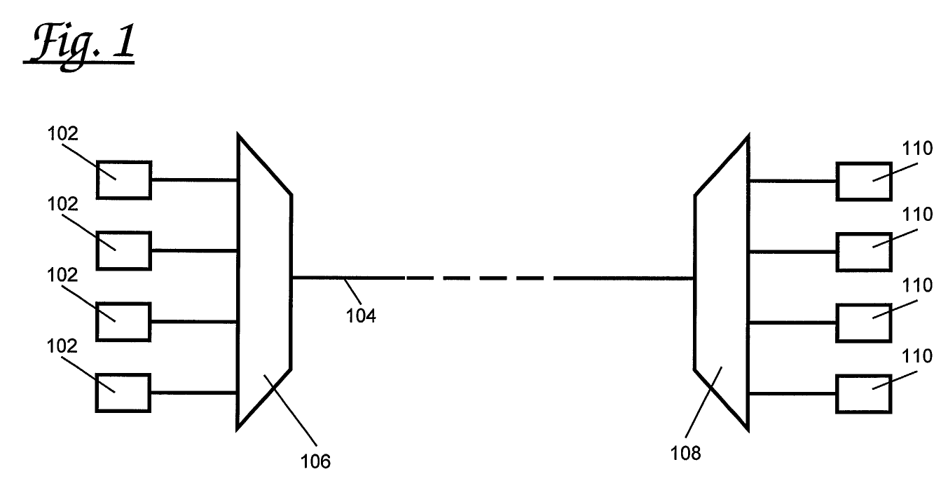

FIG. 2 shows a schematic diagram of a Prior Art optical communications network;

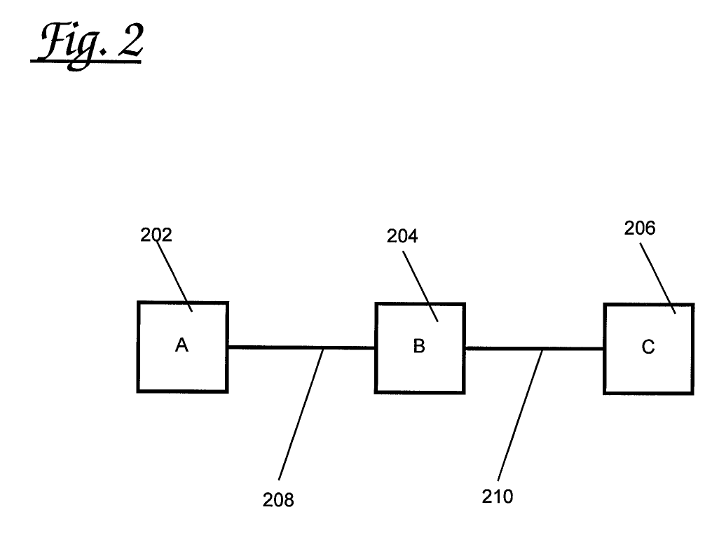

FIG. 3 shows a schematic diagram of a further Prior Art optical communications network;

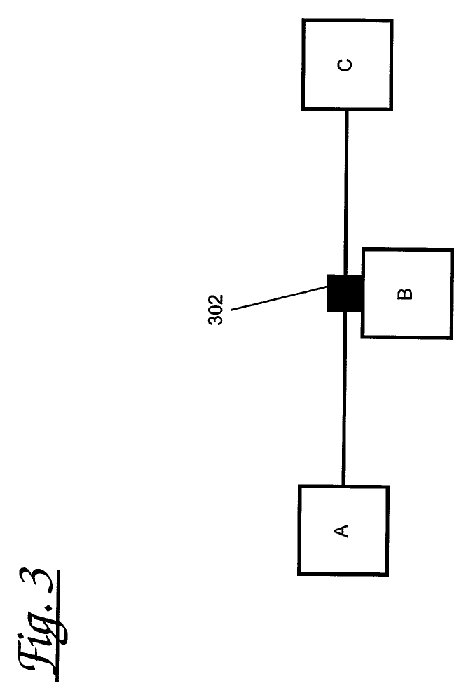

FIG. 4 shows a schematic diagram of a Prior Art OADM;

FIG. 5 shows a schematic diagram of a Prior Art AWG device;

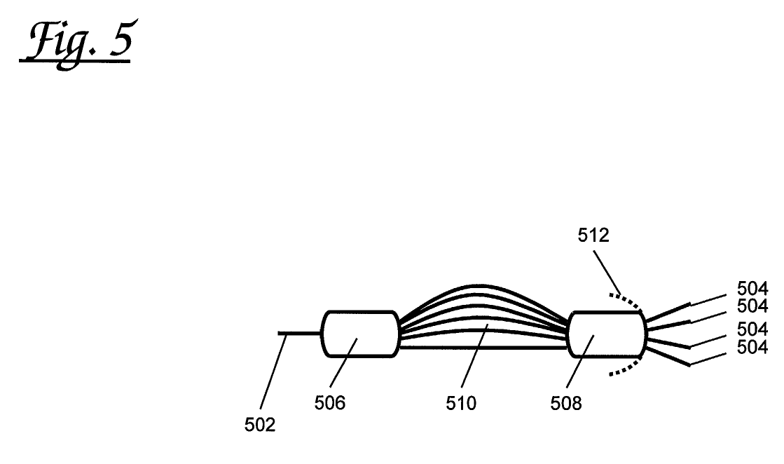

FIG. 6 shows a transmission characteristic of the Prior Art AWG shown in FIG. 5;

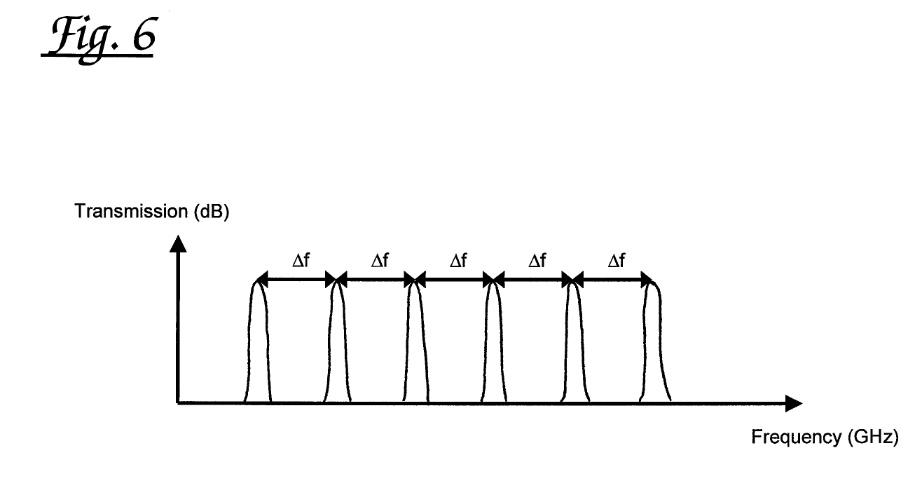

FIG. 7 shows a schematic diagram of an improved OADM device according to a first aspect of the present invention;

FIG. 8 shows an integrated 2×8 add-drop channel filter AWG device according to a first aspect of the present invention;

FIG. 9 shows a schematic diagram of an optical communications network;

FIG. 10 shows the optical channel plan for the device shown in FIG. 8;

FIG. 11 shows an integrated 2×8 add-drop channel filter AWG device according to a second aspect of the present invention; and

FIG. 12 shows the optical channel plan for the device shown in FIG. 11.

### DETAILED DESCRIPTION OF INVENTION

Embodiments of the present invention are described below by way of example only. These examples represent the best ways of putting the invention into practice that are currently known to the Applicant although they are not the only ways in which this could be achieved.

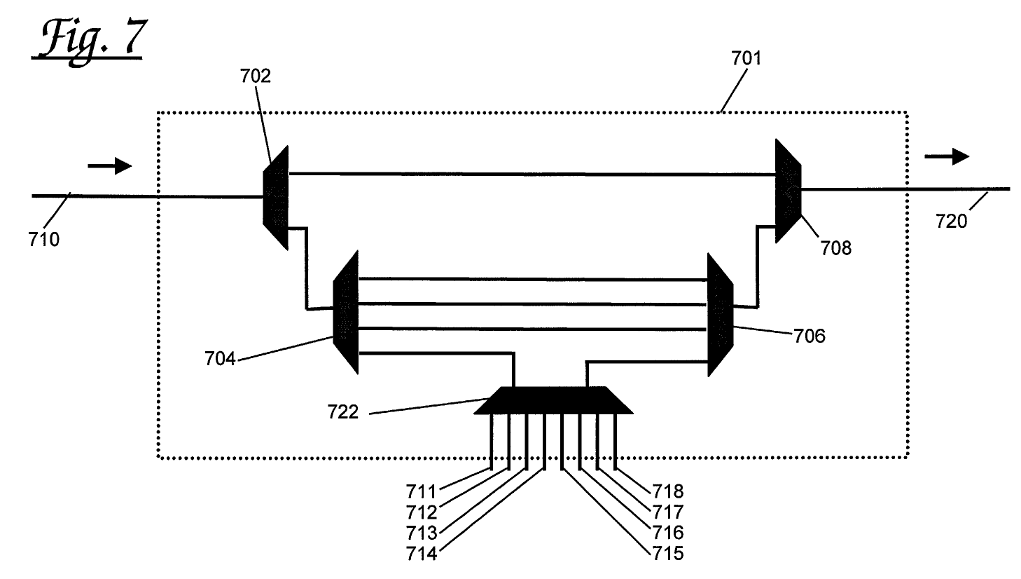

Referring to FIGS. 7-9 there is shown a first embodiment of the present invention. FIG. 7 shows a schematic diagram of an improved OADM device 701. The OADM contains two demultiplexors 702, 704, two multiplexors 706, 708, 5 input ports 710, 715-718, 5 output ports 711-714, 720 and an integrated add-drop channel filter 722.

An optical signal enters the OADM 701 along the optical input path 710. The optical signal carries 32 channels each on a different wavelength of light; channels 1-4, 6-9, 11-14, 16-19, 21-24, 26-29, 31-34 and 36-39. Every fifth channel is not used as this relaxes the wavelength accuracy and filter shape tolerances for the demultiplexors 702, 704 and multiplexors 706, 708 within the OADM. The demultiplexor 702 splits the input optical signal into two groups of wavelengths and outputs each along a different optical path. The first group of wavelengths (channels 1-4, 6-9, 11-14 and 16-19) is then input to a second demultiplexor 704, also called a band drop filter. This demultiplexor splits the group of wavelengths into 4 bands of wavelengths (channels 1-4, 6-9, 11-14, 16-19) and outputs each band along a different optical path. The first of these bands (channels 14) is then input into the integrated add-drop channel filter 722. This separates out each of the channels 1, 2, 3, and 4 and outputs each channel onto a different optical path. Each of these channels then leaves the OADM through a separate output port 711-714.

Information which is to be added at the OADM is input on channels 1-4 and each channel is input through a different one of the input ports 715-718. The integrated add-drop channel filter 722 combines these 4 channels on to a single optical path. This band of channels 1-4 is then combined with the 3 other bands of wavelengths (channels 6-9, 11-14 and 16-19) by a multiplexor 706 and output along a single optical path. This group of wavelengths (channels 1-4, 6-9, 11-14 and 16-19) is then combined with the other group of wavelengths (channels 21-24, 26-29, 31-34 and 36-39) by a second multiplexor 708 and a signal containing all 32 channels is output through an output port 720.

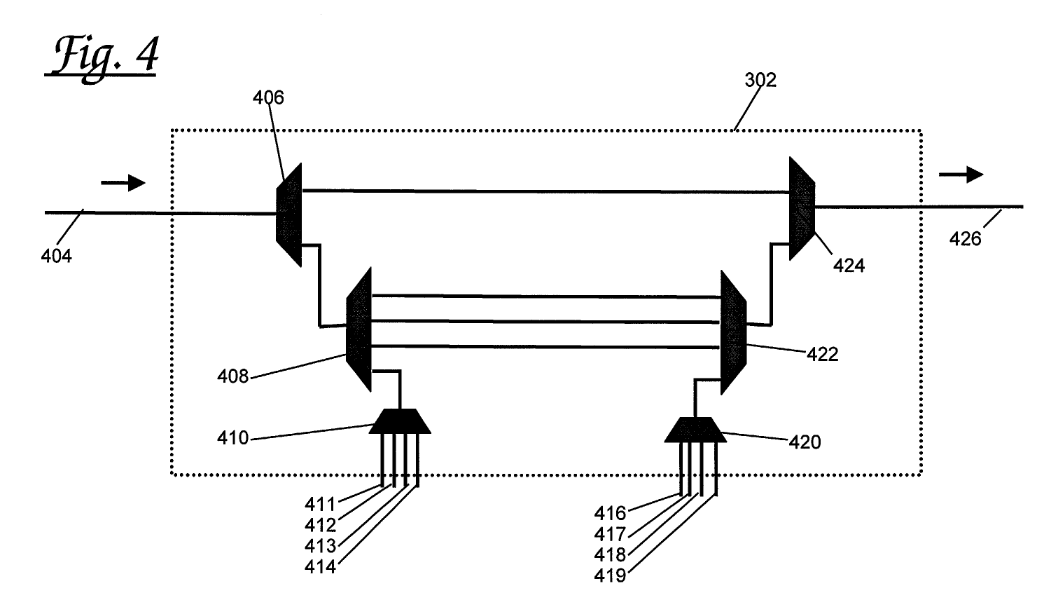

The integrated add-drop channel filter 722 combines the functions of the channel drop filter (410 in FIG. 4) and the channel add filter (420 in FIG. 4) in the Prior Art systems into a single component.

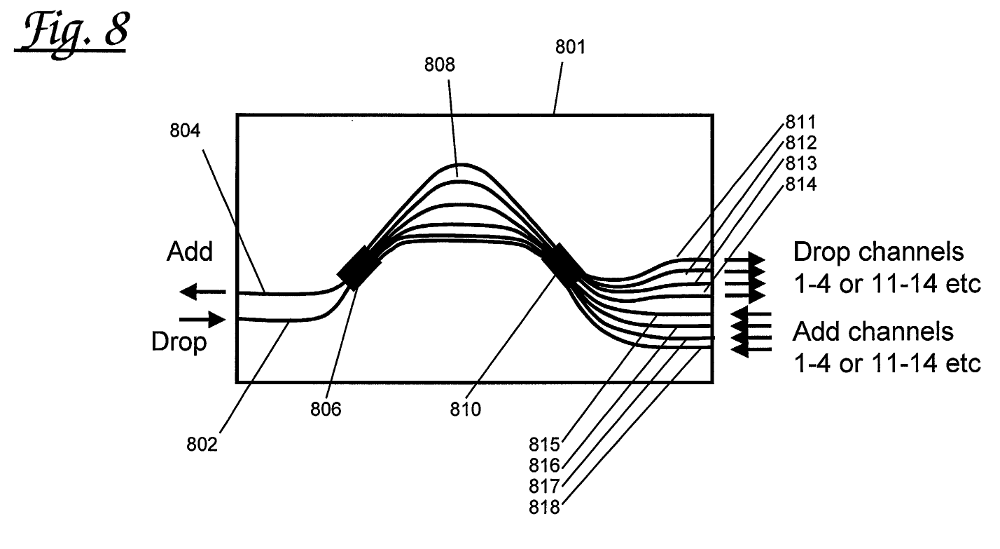

FIG. 8 shows a 2×8 AWG device 801 which could be used as the integrated add-drop channel filter 722 as shown in FIG. 7. The AWG comprises ten waveguides 802, 804, 811-818, two star couplers 806, 810 and an array of waveguides 808. An input waveguide 802 and an output waveguide 804 are connected to the first star coupler 806 and 4 output waveguides 811-814 and 4 input waveguides 815-818 are connected to the second star coupler 810. The two star couplers are connected by an array of waveguides 808. The array of waveguides 808 defines a composite optical path between the first star coupler 806 and the second star coupler 810.

Referring to FIG. 8, waveguides 802 and 804 are arranged with respect to the first star coupler 806 such that they are centered at plus one quarter of the FSR and minus one quarter of the FSR about the design center of the array of waveguides 808. The device shown in FIG. 8 might for example have an FSR of 1000 GHz and a channel spacing of 100 GHz. Waveguides 811-818 are arranged with respect to the second star coupler such that they lie in two groups of 4 waveguides such that they are aligned with the channel spacing with a skip channel between the two groups and one skip channel at each end of the FSR.

Referring to FIG. 8, waveguide 802 is the input waveguide for the channel drop filter. When an optical signal comprising channels 1-4 is input along waveguide 802, channel 1 will be output along waveguide 811, channel 2 along waveguide 812, channel 3 along waveguide 813 and channel 4 along waveguide 814.

Waveguides 815-818 are the input waveguides for the channel add filter. An optical signal of channel 1 would be input along waveguide 815, channel 2 along waveguide 816, channel 3 along waveguide 817 and channel 4 along waveguide 818. These 4 channels are multiplexed on to waveguide 804 which is the output waveguide for the channel add filter.

When the 2×8 AWG device 801 is used as an integrated add-drop channel filter to simultaneously both drop a channel and add a channel, light travels bidirectionally along the composite optical path defined by the array of waveguides 808, but in predominantly one direction through any input or output waveguide 802, 804, 811-818.

This first embodiment relates to a device where the two optical processing functions carried out by the AWG are different (a multiplexing and a demultiplexing function). A device could be designed to perform two similar optical processing functions, including, but not limited to two multiplexing functions or two demultiplexing functions. This embodiment also describes a device where the two processing functions operate on the same wavelength bands, however, a device could be designed to perform the same or different optical processing functions on different wavelengths.

The device as shown in FIG. 8 could a channel spacing of 100 GHz and an FSR of 1000 GHz and be designed for use in a system with a channel plan where every fifth channel is not used. This is shown by way of example only and the device could be designed for different channel spacing, FSR and channel plan.

The device as described could be fabricated in planar waveguide technology, including, but not limited to silica on silicon or silicon on silica technologies.

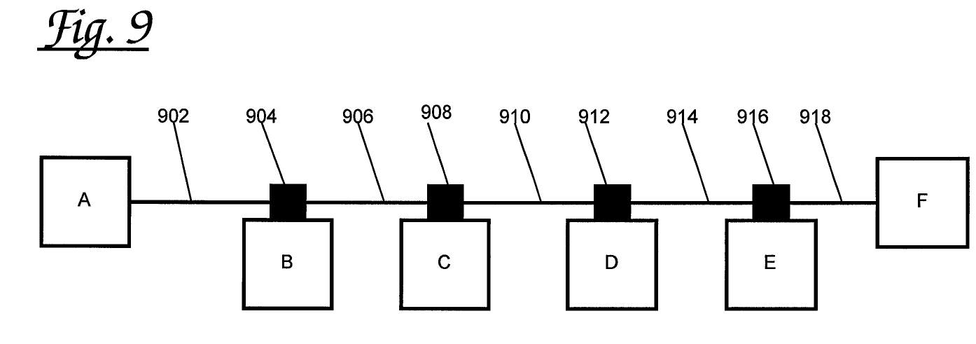

Referring to FIGS. 9-12 there is shown a second embodiment of the present invention. A schematic diagram of an optical communications network is shown in FIG. 9. The network shown in FIG. 9 connects 6 different locations, A to F. It comprises 5 optical paths 902, 906, 910, 914, 918 and 4 OADMs 904, 908, 912, 916. An optical signal sent from location A travels along optical path 902. At location B there is an OADM 904 which drops and adds channels 1-4. The signal continues along optical path 906 until it reaches location C, where an OADM 908 drops and adds channels 6-9. The signal then continues along optical path 910 until it reaches location D, where an OADM 912 drops and adds channels 11-14. The signal then continues along optical path 914 until it reaches location E, where an OADM 916 drops and adds channels 16-19. The signal then continues to location F along optical path 918.

In addition to cost, size and power consumption, another important parameter when designing an optical system, network or network element is the number of different components which are required. This is important because it relates to the size of the spares inventory which is needed in case of failure of a component.

Within the simple network shown in FIG. 9, there are 4 OADMs 904, 908, 912, 916. These OADMs could be of the type as shown in FIG. 7. In order to minimise inventory, these 4 OADMs should contain as many common components as possible. Referring back to FIG. 7, the only difference between the OADMs required for the network shown in FIG. 9 is the band of channels that need to be dropped, which means that they would require the integrated add-drop channel filter 722 to operate on a different band of 4 channels.

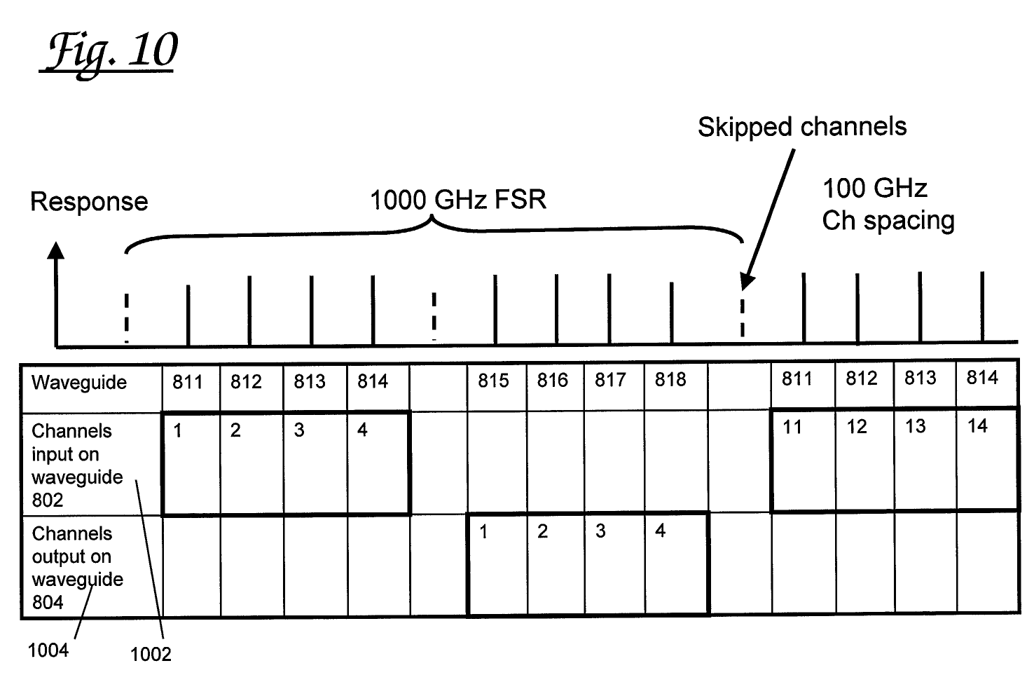

FIG. 10 shows the channel plan in frequency for the integrated add-drop channel filter according to the first aspect of this invention 801, as shown in FIG. 8. In FIG. 10, the second row 1002 in the table shows which channel is output on each waveguide of the integrated add-drop channel filter. The third row 1004 in the table shows which channels should be input on each input waveguide of the integrated add-drop channel filter. As shown in FIG. 10, this device operates on alternate channel bands, 14, or 11-14 etc. This is because the FSR of the device is 1000 GHz.

This means that such an integrated add-drop channel filter 801 would be suitable for use at location B (within OADM 904) and location D (within OADM 912) in the network shown in FIG. 9. It would not however be suitable for use at locations C or E. Therefore, in order to cover all locations within the network it would be necessary to have two such devices, as shown in FIG. 8. The first, as described above, would cover the odd channel bands (1-4, 11-14 etc) and the second, which would be the same as that in FIG. 8 but designed for a different centre wavelength, would cover the even channel bands (6-9,16-19 etc). This means that the AWG device 801 cannot be described as colourless.

The term “colourless” with reference to a WDM system means that it will operate either on any channel or on any band of channels within the optical transmission window and its performance is not specific to any channel or band of channels.

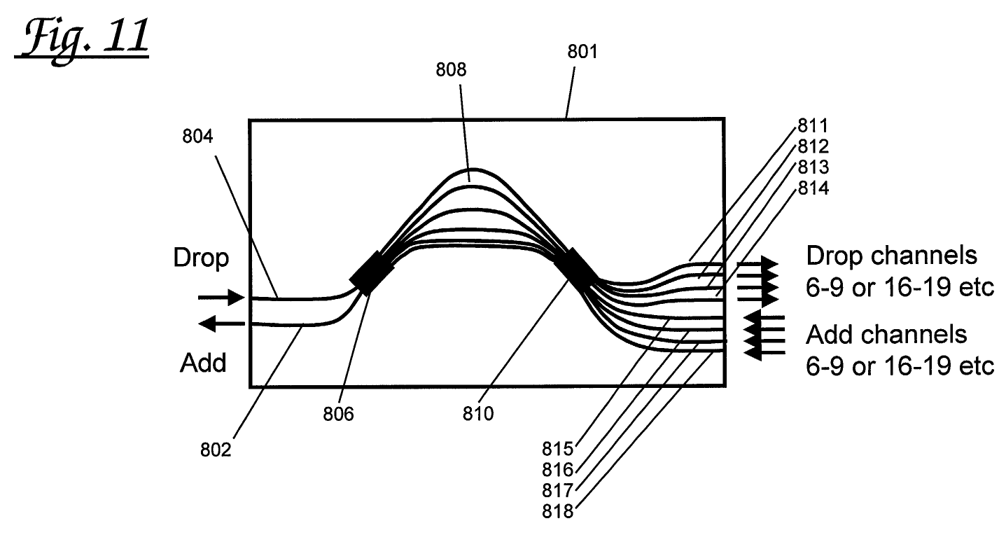

FIG. 11 shows a 2×8 AWG device 801 as shown in FIG. 8 which could be used as the integrated add-drop channel filter 722 as shown in FIG. 7. As described earlier, this device is not colourless. However by connecting the waveguides differently, a different functionality can be achieved due to the symmetry of the design.

Referring to FIG. 11, waveguide 804 is the input waveguide for the channel drop filter. When an optical signal comprising channels 6-9 is input along waveguide 804, channel 6 will be output along waveguide 811, channel 7 along waveguide 812, channel 8 along waveguide 813 and channel 9 along waveguide 814.

Waveguides 815-818 are the input waveguides for the channel add filter. An optical signal of channel 6 would be input along waveguide 815, channel 7 along waveguide 816, channel 8 along waveguide 817 and channel 9 along waveguide 818. These 4 channels are multiplexed on to waveguide 802 which is the output waveguide for the channel add filter.

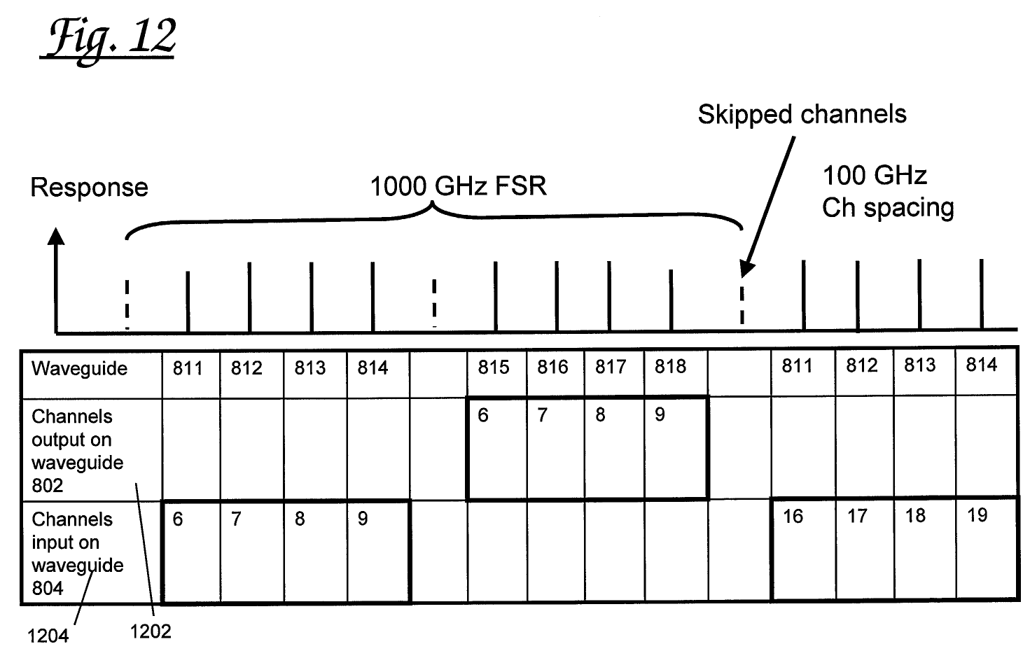

The operation of the device as described above is shown in FIG. 12. FIG. 12 shows the channel plan in frequency for the device shown in FIG. 11. In FIG. 12, the second row 1202 in the table shows which channels should be input on each input waveguide of the integrated add-drop channel filter. The third row 1204 in the table shows which channel is output on each waveguide of the integrated add-drop channel filter. As shown in FIG. 12, this device operates on alternate channel bands, 6-9, or 16-19 etc. This is because the FSR of the device is 1000 GHz.

This means that such an integrated add-drop channel filter 801 as configured in FIG. 11 would be suitable for use at location C (within OADM 908) and location E (within OADM 916) in the network shown in FIG. 9.

Consequently only one design of integrated add-drop channel filter is needed within a network as shown in FIG. 9. The integrated add-drop channel filter 801 is suitable for use at locations B, C, D and E within OADMs 904, 908, 912 and 916. In locations B (OADM 904) and D (OADM 912) the integrated add-drop channel filter would be connected as shown in FIG. 8 and in locations C (OADM 908) and E (OADM 916) integrated add-drop channel filter would be configured as shown in FIG. 11. Therefore although the AWG device 801 is not itself colourless, by changing the connections to the optical ports on the device it can achieve colourless behaviour in a network as shown in FIG. 9.

The network in FIG. 9 is shown by way of example only. In a real network there may be many more locations which are connected by means of optical paths. The network may not be a point to point network but may include other network topologies including, but not limited to rings and meshes. The OADM may also be included within a larger network element which may also include other optical functionality including, but not limited to amplification, regeneration, wavelength conversion and switching.

Although the two embodiments above describe an AWG for use as an integrated add-drop channel filter, this technique can be used to combine other combinations of optical processing function. The device can also be designed for other channel spacings, free spectral ranges and channel band plans.

Although the two embodiments above relate to AWG devices, this invention is also applicable to diffraction grating devices, including, but not limited to free space diffraction grating devices. For such devices, the composite light pathway includes a diffraction grating element.

1. An optical grating device which is capable of processing at least two optical signals concurrently, comprising a plurality of input waveguides, a plurality of output waveguides, a first free propagating region and a second free propagating region, and a composite light pathway, wherein:
a first input waveguide and a first output waveguide are connected to said first region;
a second input waveguide and a second output waveguide are connected to said second region;
and said first region and said second region are connected by the composite light pathway
and wherein light input along the first input waveguide is able to pass through the composite light pathway to be output through the second output waveguide and light input along the second input waveguide is able to pass through the composite light pathway to be output through the first output waveguide.

2. An optical grating device as claimed in claim 1 wherein the composite light pathway is an array of waveguides.

3. An optical grating device as claimed in claim 1 wherein the composite light pathway includes a diffraction grating element.

4. An optical grating device as claimed in claim 1 wherein light input along a plurality of input waveguides is able to pass through the composite light pathway to be output through at least one output waveguide.

5. An optical grating device as claimed in claim 1 wherein light input along at least one input waveguide is able to pass through the composite light pathway to be output through a plurality of output waveguides.

6. An optical grating device as claimed in claim 1 wherein the optical grating device subjects light travelling in a direction from the first free propagating region to the second free propagating region to a first optical processing function and wherein the arrayed waveguide grating device subjects light travelling in a direction from the second free propagating region to the first free propagating region to a second optical processing function.

7. An optical grating device as claimed in claim 6 wherein the first optical processing function and the second optical processing functions are substantially the same.

8. An optical grating device as claimed in claim 6 wherein the first optical processing function is a multiplexing function and the second optical processing function is a demultiplexing function.

9. An optical grating device as claimed in claim 7 wherein the first and second optical processing functions are multiplexing functions.

10. An optical grating device as claimed in any of the preceding claims which is fabricated in silica on silicon technology.

11. An optical grating device as claimed in any of claims 1-9 which is fabricated in silicon on silica technology.

12. An optical grating device as claimed in any of claims 1-9 for use as an integrated add-drop channel filter.

13. An optical network element containing an optical grating device as claimed in any of claims 1-9.

14. An optical network element as claimed in claim 13 for use as an optical add-drop multiplexor.

15. An optical system containing an optical grating device which is capable of processing at least two optical signals concurrently, comprising a plurality of input waveguides, a plurality of output waveguides, a first free propagating region and a second free propagating region, and a composite light pathway, wherein:
a first input waveguide and a first output waveguide are connected to said first region;
a second input waveguide and a second output waveguide are connected to said second region;
and said first region and said second region are connected by the composite light pathway
and wherein light input along the first input waveguide is able to pass through the composite light pathway to be output through the second output waveguide and light input along the second input waveguide is able to pass through the composite light pathway to be output through the first output waveguide.

16. An optical grating device which is capable of processing at least two optical signals concurrently, comprising a plurality of input waveguides, a plurality of output waveguides, a first free propagating region and a second free propagating region, and a composite light pathway, wherein:
a first input waveguide and a first output waveguide are connected to said first region;
a second input waveguide and a second output waveguide are connected to said second region;
and said first region and said second region are connected by the composite light pathway
and wherein light travels in two directions through the composite light pathway and in predominantly one direction through any input or output waveguide.

17. An optical system containing an optical grating device which is capable of processing at least two optical signals concurrently, comprising a plurality of input waveguides, a plurality of output waveguides, a first free propagating region and a second free propagating region, and a composite light pathway, wherein:
a first input waveguide and a first output waveguide are connected to said first region;
a second input waveguide and a second output waveguide are connected to said second region;
and said first region and said second region are connected by the composite light pathway
and wherein light travels in two directions through the composite light pathway and in predominantly one direction through any input or output waveguide.
